(19) United States
(12) Patent Application Publication
(10) Pub. No.: US 2026/0202433 A1
(43) Pub. Date: Jul. 16, 2026

(54) FOOD DEFENSE SYSTEM

(71) Applicant: ANCERA, INC., Branford, CT (US)

(72) Inventors: Matthew Zwilling, New Haven, CT (US); Thabani Dhlakama; Zoe Moscato, Orange, CT (US); Brian Westgate, Middlefield, CT (US); Robert Zakrzewski, Wallingford, CT (US); Quentin Brosseau, New Haven, CT (US); Arjun Ganesan, Charleston, SC (US)

(21) Appl. No.: 19/434,743

(22) Filed: Dec. 29, 2025

Related U.S. Application Data
(60) Provisional application No. 63/739,969, filed on Dec. 30, 2024.

(51) Int. Cl. G01N 35/00; G01N 35/02

(52) U.S. Cl. CPC G01N 35/0099; G01N 35/00584; G01N 35/021; G01N 2035/00306; G01N 2035/00356; G01N 2035/00435; G01N 2035/00495

(57) ABSTRACT

A food defense system includes: a housing; at least one assay station mounted within the housing; at least one reagent station mounted within the housing; a supply of assay vessels residing within the housing; a conveyance unit configured to move the assay vessels to the at least one assay station; and a controller operatively connected with at least one of the at least one assay station, the conveyance unit, and the at least one reagent station.

### RELATED APPLICATION

The present application claims priority from and the benefit of U.S. Provisional Patent Application No. 63/739,969, filed Dec. 30, 2024, the disclosure of which is hereby incorporated herein by reference in full.

### FIELD OF THE INVENTION

The present application is directed to food and animal health testing facilities, and more specifically to on-site testing facilities.

### BACKGROUND OF THE INVENTION

Food production is essential to the well-being of all people. Of course, the speedy production of any foodstuff must be balanced with assurances that the food is safe for consumption. This can create significant challenges. For example, the global poultry supply chain is vast and interconnected; however, poultry production is inherently vulnerable to malicious and microbial threats.

Despite the industry's annual investment of over $1 billion in vaccines, antimicrobials, and feed additives, many poultry companies lack a strong defense system that leverages data to optimize these expenses. This lack of quality data turns what should be an informed decision into a guess, and that guess can cost you in operational efficiency, compliance risk, and profitability. “Food defense” is built to solve these problems. Threats are monitored and decision-makers can stay ahead of them before they affect operations. As used herein, “Food Defense” includes, but is not limited to: environmental monitoring; testing inside ready-to-cook or ready-to-eat processing plants (including all testing required by regulatory agencies, and tests to confirm cleaning processes); food-borne pathogen testing; animal health disease monitoring (including gut health or respiratory viral diseases); monitoring of vaccine efficacy; and, testing of feed, ingredients, and process inputs. Facilities can include food processing facilities as well as farms.

A contemporary definition of food defense encompasses the protection of the food supply chain from both intentional contamination (bioterrorism or sabotage) and unintentional contamination including microbial or chemical threats. In the poultry industry, this means monitoring every component, from environmental controls to feed and water supplies, to the health products used on birds.

Traditional methods of poultry facilities management and production optimization rely on reactive rather than proactive measures. It may be desirable to provide an integrated food defense strategy, in which risks are identified in real-time, outcomes are predicted and analyzed, and targeted interventions can be implemented quickly.

### SUMMARY OF THE INVENTION

As a first aspect, embodiments of the invention are directed to a food defense system. The food defense system comprises: a housing; at least one assay station mounted within the housing; at least one reagent station mounted within the housing; a supply of assay vessels residing within the housing; a conveyance unit configured to move the assay vessels to the at least one assay station; and a controller operatively connected with at least one of the at least one assay station, the conveyance unit, and the at least one reagent station.

As a second aspect, embodiments of the invention are directed to a food defense system comprising: a housing; a plurality of assay stations mounted within the housing; a plurality of reagent stations mounted within the housing; a supply of assay vessels residing within the housing; a conveyance unit configured to move the assay vessels to one or more of the assay stations; and a controller operatively connected with at least one of the assay stations, the conveyance unit, and the reagent stations.

As a third aspect, embodiments of the invention are directed to a food defense system that can be configured to perform specific food defense related assays on-site at a food production-related facility. The food defense system comprises: at least one station for performing a food defense-related assay; at least one station for providing at least one reagent for performing the assay; and a conveyance unit for moving at least one component related to the assay to enable performance of the assay. In particular, this system may be implemented at location close to or at the source of the samples being tested. This can eliminate delays related to the time required to ship samples to a testing lab, thereby removing result artifacts related to sample degradation or pathogen growth.

As a fourth aspect, embodiments of the invention are directed to a food defense system designed for use on-site at a food production related facility to provide rapid analysis of samples.

### BRIEF DESCRIPTION OF THE FIGURES

FIG. 1 is a perspective view of a food defense system according to embodiments of the invention.

FIG. 2a is a schematic plan view of a handling deck for a food defense system according to other embodiments of the invention showing the general layout of stations and other equipment.

FIG. 2b is a schematic plan view of a handling deck as in FIG. 2a illustrating an exemplary layout for conducting assays that involve direct labelling of pathogens.

FIG. 2c is a schematic plan view of a handling deck as in FIG. 2c illustrating another exemplary layout for conducting assays that involve direct labelling of pathogens.

FIG. 3 is a schematic plan view of a food defense system designed to run a Total Viability Bacteria (TVB) assay according to alternative embodiments of the invention.

FIG. 4 is a perspective view of a custom metal fixture that allows easy pickup and stacking of custom ferrofluidic assay cartridges, compatible with stations of the handling deck of FIG. 3.

FIG. 5 is a perspective view of a custom metal fixture that can accommodate a 24-well deep well plate for a food defense system according to embodiments of the invention.

FIG. 6 is a perspective view of a custom metal fixture that can accommodate a 96-well deep well plate for a food defense system according to further embodiments of the invention.

FIG. 7 is a perspective view of a custom fixture supporting an array of pressure sensors, that allow the verification of the nominal operation values of a ferrofluidic assay system that can be used in a food defense system for verifying operational settings of the system.

FIG. 8 is a perspective view of a custom fixture for supporting an array of magnetic field sensors and one light intensity sensor that allow the verification of the nominal operational settings of a ferrofluidic assay system.

FIG. 9 is a chart comparing the time required for manual testing of a sample for TVB with the time required for testing using a system according to embodiments of the invention.

FIG. 10 is a table listing the steps required for testing of a sample for Listeria that compares the number of human-required steps for completely manual testing (Column 2), using a commercially-available liquid handler (Column 3) and a completely automated system according to embodiments of the invention (Column 4).

### DETAILED DESCRIPTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

Various terms such as “pathogen”, “microbe” and the like are used herein, and are intended to encompass microorganisms that include bacteria, fungi, viruses, parasites, protozoa, algae, archaea and prions. The term “pathogen” refers to a bacteria, virus or other microorganism that can cause disease. “Non-pathogenic” microbes and microorganisms can also be monitored in practicing embodiments of the invention, as they can contribute to the health of a host (i.e. a chicken, swine, etc). The methods, components and operations described in this application are intended to be applicable to the identification of any microbe (whether pathogenic and non-pathogenic) as well as to non-microbial materials (e.g., toxins, chemicals, nutritional compounds), several of which are described below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

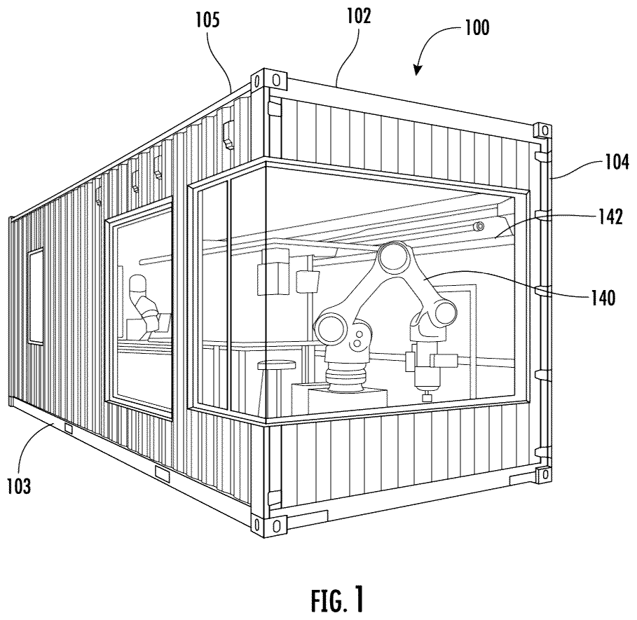

Referring now to the figures, a food defense system is designated broadly at 100 and illustrated in FIG. 1. The system 100 has an enclosure 102 shown herein as being generally box-shaped and having the general dimensions of a standard shipping container (i.e., about 8 feet in width, between 8 and 10 feet in height, and 20 to 40 feet in length). Such dimensions may have benefits in transport and installation (as the system 100 can be loaded, transported, unloaded, and positioned in a similar manner as a standard shipping container), but in some embodiments the enclosure 102 may take other dimensions. In some instances the system 100 may be positioned such that it is contiguous with a food processing facility, such that samples from the facility can be transported directly to the system 100 for testing. In other embodiments, the enclosure 102 may be a standard shipping container that is slightly or significantly modified.

The enclosure 102 serves as an outer shell to protect the components housed therein. The enclosure 102 may have various discontinuities in its floor 103, walls 104 and ceiling 105 to permit and facilitate operations. For example, the walls 104 may have cutouts for one or more doors that permit entry for technicians, and/or for windows that allow visual access. The floor 103, walls 104 and/or the ceiling 105 may also have ports for power and telecommunication and data communication signals, ducts for the ingress and egress of water and air, and similar features. The enclosure may be under positive pressure. Incoming air may be HEPA filtered. As another example, the ceiling 105 may include provision for an antenna or other signal-receiving device to support the transmission of signals to and from the system 100. Other variations may be apparent to those of skill in this art.

In many embodiments, any discontinuities in the floor, walls and ceiling should include an airtight seal. Such seals can help to ensure that contaminants that might compromise testing results are not able to penetrate the housing 102 during testing.

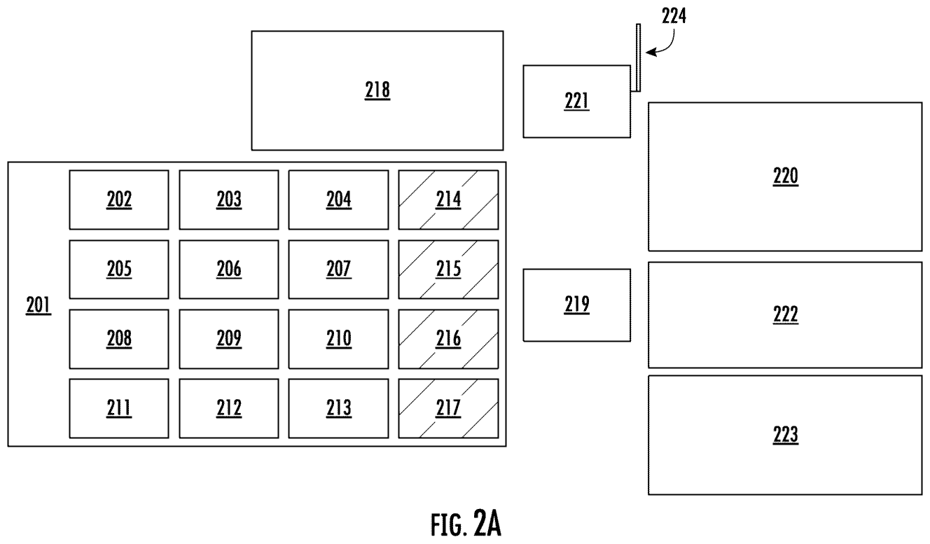

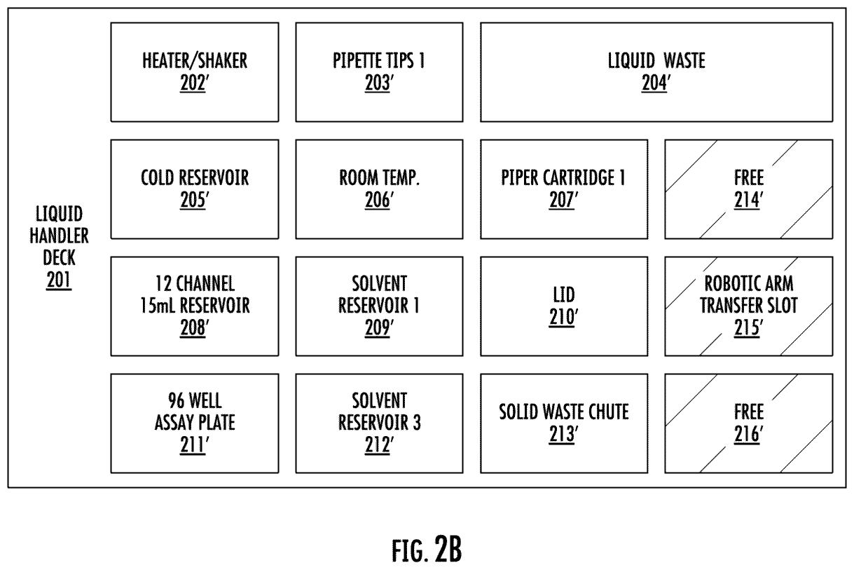

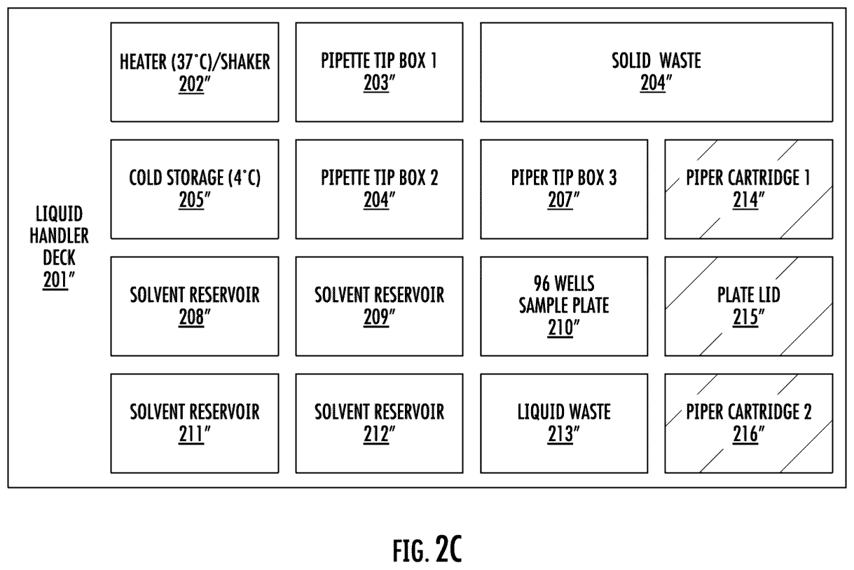

Referring now to FIG. 2a, an exemplary schematic layout of operational components of the food defense system 100 are shown therein. As shown in FIG. 2a, a liquid handling deck 201 space is separated into 16 slots or stations 202-217 that can accommodate sample plates, sample lids, custom fixtures, custom cartridges, or reagent containers, and the like. The deck locations 202-217 can be used to position assay plates, reagent plates, pipette tips in positions to meet the requirements of a specific assay used to test samples from products of interest, or other supplies. (As used herein, the word “vessel” is intended to encompass both plates and cartridges, whether used for samples, reagents, or assays).

As one example, at a poultry processing facility, assays may be conducted for pathogens such as coccidia, Salmonella, Listeria, Clostridium, Campylobacter, E. coli, various viruses (including avian influenza viruses such as HPAI (highly pathogenic avian influenza) and other pathogenic bacteria, parasites and viruses. At a swine processing facility, assays that may be conducted can include Salmonella, E. coli, Staphylococus aureus, Campylobacter and other pathogenic bacteria, parasites and viruses. At other food processing facilities, a range of pathogen tests are routinely performed to assess food safety and animal health. Similar testing can be performed throughout the food production process, such as: testing to test food quality and/or contamination; testing to access the effectiveness of vaccines; tests to monitor the health of a flock or herd; and testing of deceased animals to determine the cause of death. All of these testing situations can be important components of a food security monitoring process. Those of skill in this art will appreciate that other types of assays may also be suitable for inclusion in the food defense system 100. Moreover, the illustration of stations shown in FIG. 2a is exemplary only; the specific set up of the liquid handling deck is specific for the assay being performed. The stations 202-217 may also provide any function that may be necessary or helpful in the conducting of the assays at the assay stations.

Stations 214 to 217 can be accessed by a self-standing robotic arm 219. The robotic arm 219 may be any robotic system that is recognized as being suitable for the conveyance and manipulation of assay samples, reagents, fixtures, assay plates, cartridges and the like. The robotic arm can either be fixed in one location, or attached to a rail is present to enable to robotic arm 219 to move its position within the housing 102, but in some embodiments the robotic arm 219 may have sufficient reach or the stations may be arranged such that the rail or a similar guide is not required.

A gantry-based gripper system 218 is also shown in FIG. 2a. The gantry system 218 typically includes pipettors and a gripper. The gantry system 218 typically has access to all 16 positions on the deck 201. Also, the gantry system 218 can move plates to positions 214-216 so that the robotic arm 219 can move plates into an off-deck component (discussed below), such as a centrifuge, or a microplate reader (spectrophotometer) or a RT-PCR system.

Moreover, in some embodiments the assay plates may be arranged such that a plate can be conveyed between stations without the need for a robotic arm. For example, plates may be conveyed between stations via a conveyance unit such as a conveyor belt, an inclined channel, a magnetized carriage, or the like.

Also shown schematically in FIG. 2a is a controller 221, which is operatively connected with the liquid handling deck 201, the gantry system components 218, the robotic arm 219 and the off-deck components 220-222. The off-deck components 220-222 may include a plate centrifuge, a fluorescence or absorbance spectrophotometer (for microplates), a Piper® ferrofluidic assay system (such assays are described, for example, in U.S. Patent Publication No. 2024/0287585, the disclosure of which is hereby incorporated herein by reference in full), a plate/cartridge ‘hotel’ that can contain an incubator, assay plates, assay cartridges, and reagent plates, reagent reservoirs, pipette tips, etc., or the like. In some cases, more than three off-deck analysis systems may be available for use. The controller 223 can receive instructions to move the gantry/gripper or pipettor 218 along the rail 142 and between the deck locations as needed to carry out assay operations. The controller 223 may also be configured to process the results of assays conducted at the stations 214-216.

Further, an antenna 224 is shown in FIG. 2 to be operatively connected with the controller 223. The antenna mounted on the exterior of 103 and connected to the controller 223. The antenna 224 can send and receive signals that, through the controller 223, control the operation of the assay deck, robotic arm 219 and off deck components 220, 222 and provide assay results to locations connected to or remote from the food defense system 100. The results may be employed in such locations to create plans for dealing with any abnormalities (e.g., pathogenic and/or non-pathogenic microbes, contaminants, nutritional information, etc., as discussed below) identified in the assays.

The assay system described above is not limited to the assay examples illustrated elsewhere in this application. The assay deck system, robotic arm and off deck capabilities can be set up to run other common types of assays and sample processing used in food security laboratories. The types of assays include but are not limited to: assays involving cell labeling; fluorescence in-situ hybridization (FISH) assays; molecular assays such as PCR, RT-PCR, LAMP and other molecular assay types; standard bacteria culture-based assays; immunoassays; and DNA/RNA sequencing. The assays may be directed to the detection of pathogenic and/or non-pathogenic microbes.

The assays may also be directed to other types of testing. For example, the presence of certain chemicals may be detected. Such chemicals may include antibiotics, vitamins, toxins, allergens, heavy metals and the like. Exemplary chemicals for testing include fluoroquinolone, soy protein, aflatoxin, arsenic, and mercury. The assays may also be directed to the testing of nutritional value of animals within a food processing facility (for example, analyses of protein, fat content, moisture, minerals and vitamins may be conducted). In addition, proximate analysis (a technique to measure the chemical properties of a compound based on four particular elements: moisture content, fixed carbon, volatile matter and ash content) may be conducted.

Moreover, the system 200 may be configured to prepare samples that are tested outside of the system 200. As one example, the system 200 may be used to prepare samples for high-performance liquid chromatography (HPLC) or mass spectroscopy analyses that may be conducted inside or outside of the system 200. Other examples include DNA or RNA sequencing, and other complex analyses that may require prolonged analysis times.

In some embodiments, it may be desirable for the food defense system 100 to be located on-site with a food processing plant (e.g., a poultry processing facility, a poultry farm, an egg laying farm, a feed mill, etc.). In certain embodiments, the system 100 may be adjacent with or connected to a wall of the food processing plant, such that samples (e.g., atmospheric samples from inside the plant) can be drawn and deposited directly into the food defense system 100 for assaying.

FIG. 2b illustrates a specific exemplary layout of stations that can be employed with the deck 201 that may, in particular, be suitable for pathogen labelling based assays in 96-well assay plates. In FIG. 2b, there are 2 dedicated stations: station 202′ is a microplate heating/shaker unit; and station 205′ is a chilling station where an assay plate can be kept cold (e.g., using a Peletier-based chiller). Stations 203′, 204′, and 206′-213′ can be deployed with variable uses/items including: assay plates, reagent plates, reagent reservoirs, pipette tips, liquid waste collection, solid waste disposal chute, cartridges, and plate lids. Stations 214′-216′ are accessible by the robotic arm 219 shown in FIG. 2a. The robotic arm 219 can be used to position plates, cartridges, lids, and reagents plates or reservoir to positions 214′-216′, where they can be moved to other positions by the gantry system 218 shown in FIG. 2a. The gantry system 218 can also move plates to positions 214′-216′ so the robotic arm 219 can move plates to one of the off-deck components discussed above.

Specifically, the stations of the layout shown in FIG. 2b are listed below in Table 1.

TABLE 1

| Station | Supply/Function |
|---|---|
| 202′ | Heater/Shaker |
| 203′ | Pipette tips |
| 204′ | Liquid waste |
| 205′ | Cold reservoir |
| 206′ | Room temperature reservoir |
| 207′ | Ferrofluidic assay cartridges |
| 208′ | 12 channel 15 mL reservoir |
| 209′ | Solvent reservoir |
| 210′ | Lids |
| 211′ | 96 well assay plates |
| 212′ | Solvent reservoir |
| 213′ | Solid waste |
| 214′ | Free |
| 215′ | Robotic arm transfer slot |
| 216′ | Free |

FIG. 2c illustrates another layout for a deck 201 that may, in particular, be suitable for assays involving labelling of pathogens in 24-well assay plates. This layout includes stations 202″-216″ and, as with the layout shown in FIG. 2b, and also enables access to the robotic arm 219 and the gantry system 218 shown in FIG. 2a. The specific stations of the layout of FIG. 2c are listed below in Table 2.

TABLE 2

| Station | Supply/Function |
|---|---|
| 202″ | Heater/Shaker |
| 203″ | Pipette tips |
| 204″ | Solid waste |
| 205″ | Cold reservoir |
| 206″ | Pipette tips |
| 207″ | Pipette tips |
| 208″ | Solvent reservoir |
| 209″ | Solvent reservoir |
| 210″ | 24 well assay plates |
| 211″ | Solvent reservoir |
| 212″ | Solvent reservoir |
| 213″ | Liquid waste |
| 214″ | Ferrofluidic assay cartridges |
| 215″ | Lids |
| 216″ | Ferrofluidic assay cartridges |

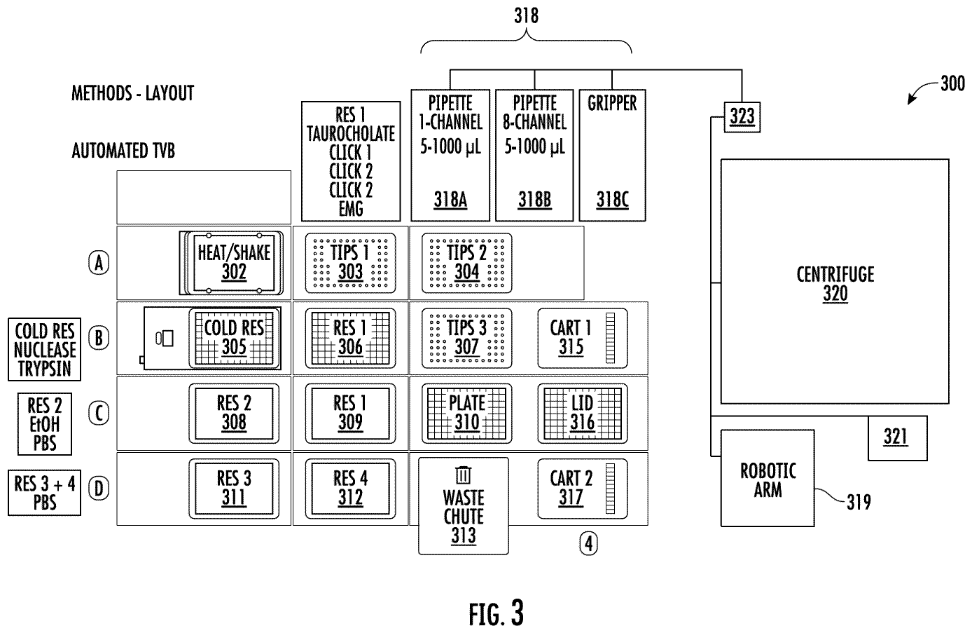

A layout for a food defense system set up for assaying total viable bacteria (TVB) in various samples (such as poultry rinsate, environmental swabs, etc) is shown in FIG. 3 and designated broadly as 300. The food defense system 300 may be particularly suitable for the assaying samples from a poultry production facility. The system 300 (which is contained in a housing such as the housing 102 described above) includes as reservoir stations 301, 302, 303, 304, 305, each of which contains reagents that are used in the TVB assay. For example, station 306 (labeled Res 1) contains reagents taurocholate, “Click” 1 reagent, “Click” 2 reagent, “Click” 3 reagent and EMG reagent (ferrofluid), positioned in wells of the plate. Station 308 (labeled Res 2) contains wells of ethanol and phosphate buffered saline (PBS). Station 311 (labeled Res 3) and station 312 (labeled Res 4) contain PBS. Station 305 is a cooled (refrigerated or iced) reservoir that includes a nuclease and trypsin. Station 310 contains the TVB assay plates. Station 316 contains the lids for the assay plates in station 310. Upon completion of the assay, aliquots from the sample plate are transferred to wells of the cartridges in stations 315 and 317 for processing on the external ferrofluidic assay system. Cartridges are inserted into the ferrofluidic assay system by the robotic arm 319. Details regarding a TVB assay are discussed in PCT Publication No. WO 2023/245172, the disclosure of which is hereby incorporated therein by reference in full.

The food defense system 300 also includes automatic pipettors 318a and 318b attached to a gantry system 318 positioned over the assay deck. The gantry system 318 moves the pipettors to the plates where needed to add or remove reagents from the assay plate wells. Also attached to the gantry 318 is a gripper 318c which can move plates from one position to another on the assay deck. The pipettors 318a and 318b are used to pipette reagents into cartridges or microtiter plates for performing an assay. They can also be used to add and remove liquids from wells to facilitate washing if necessary. Stations 301, 303, and 307 are illustrated as supply stations for pipette tips, which are ordinarily replaced after each use.

The food defense system 300 also includes additional specialty stations that may be used for specific assays. A plate heating/shaking station 302 is configured to heat and/or agitate assay reagents and/or samples as needed. An off-deck centrifuge 320 accessible by the robotic arm 319 is present to centrifuge samples as needed. A waste chute 323 is present to assist in the disposal of sample materials, spent reagents, used pipette tips, and other waste.

The robotic arm 319 like that described above is included in the food defense system 300 to transport materials (sample, reagents, waste, etc.) between the various stations therein, and in particular between off-deck components (e.g., the centrifuge, incubator, spectrometers, RT-PCR system, etc.) and the on-deck stations 301-317. Those of skill in this art will appreciate that the robotic arm 319 may be located in other positions, depending on the space/reach requirements. Also, some systems may employ more than one robotic arm, or may combine the use of a robotic arm with other means of conveying cartridges, supplies, reagents, and the like.

The food defense system 300 also includes a controller 323 (shown schematically in FIG. 3). The controller 323 is operatively connected with at least some of the components described above, including (but not limited to) the robotic arm 319, the deck stations 302-317, and the centrifuge 320. The controller 323 may also be operatively connected with one, some or all of the reservoirs 306, 308, 309 and 312, and may include the capacity to track usage levels for each to alert an operator to the need for replenishment. The controller 323 may also be configured to process the results of assays obtained from the off-deck assay readers (need to add these to the figure). Assay results can be sent via the controller 323 through an antenna (such as is designated as 224 in FIG. 2a) to locations remote from the food defense system 100.

Those skilled in this art will appreciate that any of the aspects of the discussion above regarding the system 100 (FIG. 1) and the systems 200, 200′, 200″ in FIGS. 2a-2c may also be applicable to the system 300.

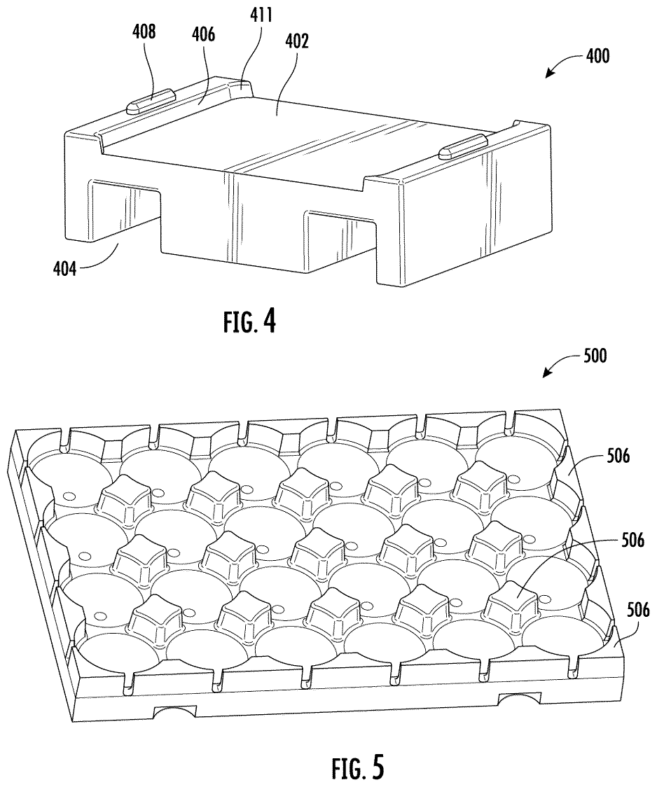

Referring now to FIG. 4, designated broadly at 400, is a. custom metal fixture that allows easy pickup and stacking of custom Piper cartridges (i.e., cartridges for ferrofluidic assays), compatible with a liquid handler deck slot (202-216). The fixture 400 includes a block-like main body 402, recesses 404 in its lower surface, and upstanding flanges 406 on opposite ends of the main body 402. The recess 404 aligns with the reagent/sample well of a Piper cartridge. Each flange 406 includes a vertically-extending tab 408 and an angled lip 410 at one end. Tab 408 aligns with a recess in the bottom of flange (not shown) to facilitate stable stacking. The fixture 400 is configured to receive a cartridge from any of the cartridge stations described above and maintain it in position for fluid dispensing.

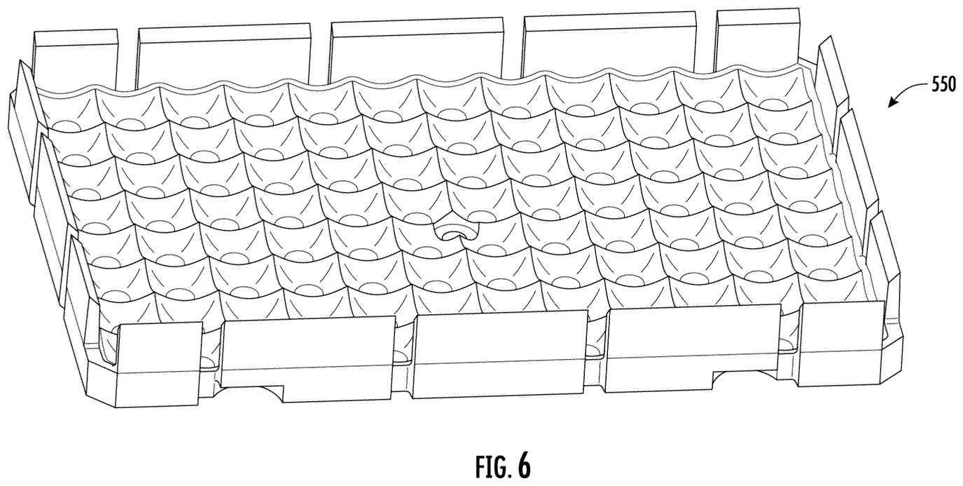

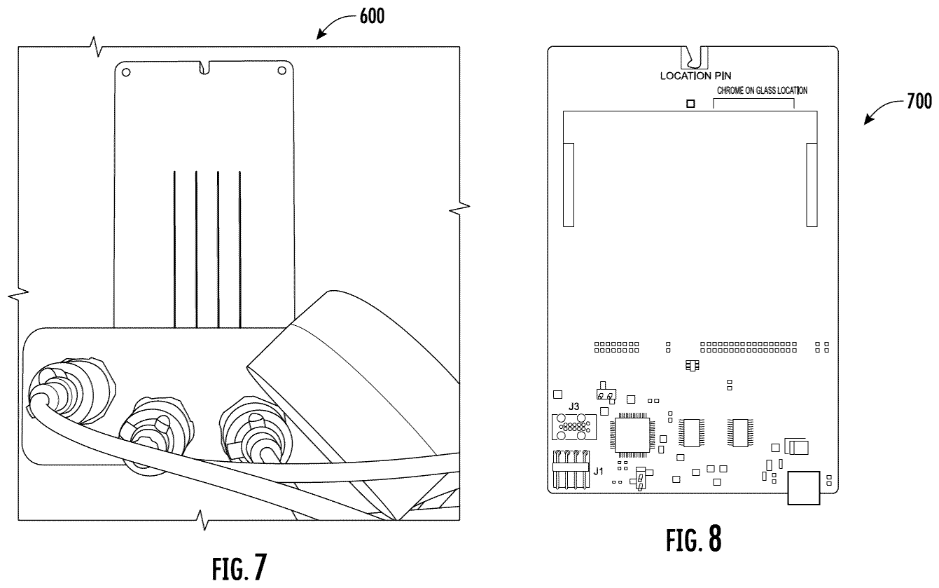

FIG. 5 illustrates a custom metal fixture that can accommodate an Eppendorf 24-well deep plate (at present, a commercial fixture does not exist for this product). The fixture 500 enhances the heat transfer between a target sample and a temperature control system compatible with the heater/shaker and/or cooler stations described above. The fixture 500 has a main body 502, a plurality of diamond-shaped projections 504, and a plurality of fence members 406 that extend upwardly from the perimeter of the main body 502. The bottom of each well position of the metal fixture matches the curvature of the round bottom wells to enable uniform heat transfer. The fixture 400 can receive a 24-well plate and is intended to permit the simultaneous heating of any samples residing in the 24-well plate. FIG. 6 illustrates a somewhat similar fixture 550 that is configured to receive a 96-well plate.

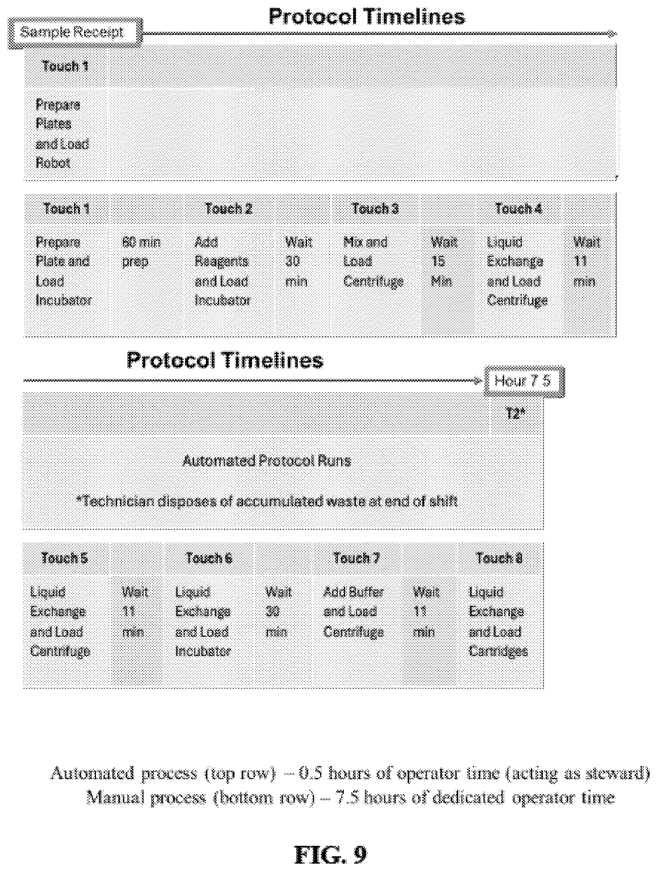

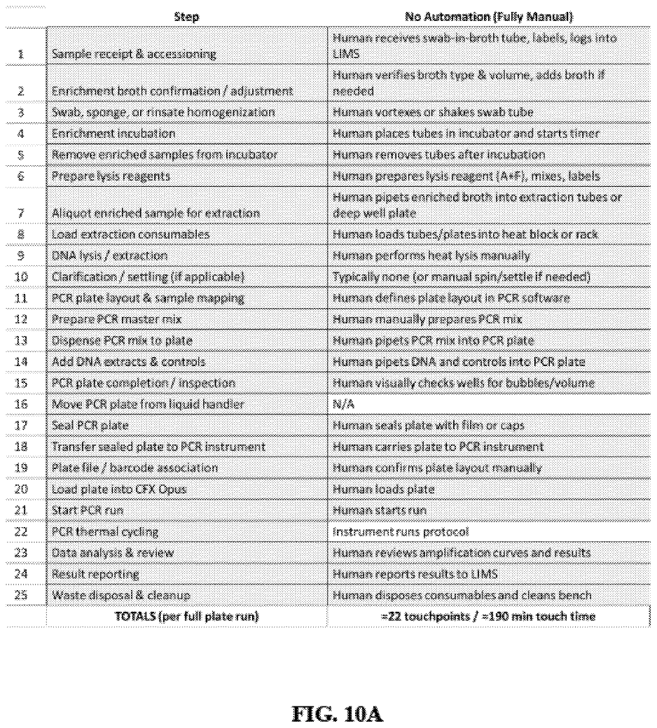

FIGS. 7 and 8 illustrate internal fixtures 600 and 700 that are shaped like a typical cartridge and that can be inserted into a dock on the cartridge stations 206, 207. The fixture 600 (FIG. 7) is a custom fixture supporting an array of pressure sensors, that allow the verification of the nominal operation values of the Piper detection system 221. It can be handled by a robotic arm and communicates data through wireless or cable signal. It can serve as a part of a Self-QC system for the Piper detection system 221 without human intervention. The fixture 700 (FIG. 8) is a custom fixture for supporting an array of magnetic field sensor and one light intensity sensor, that allow the verification of the nominal operation values of the Piper detection system 221. It can be handled by a robotic arm and communicates data through wireless or cable signal. It can serve as a part of a Self-QC system for the Piper detection system 221 without human intervention.

Those of skill in this art will appreciate that the food defense systems discussed above may take different configurations. For example, the stations of the food defense systems may be arranged differently: as one example, they may be arranged in a U-shape or L-shape, such that the reach of the robotic arm may be less. Such an arrangement may also make it possible for a human operator to perform some or all of the operations in certain situations. It is also contemplated that some of the stations may be vertically “stacked” (i.e., one station may be positioned directly above or below another) in order to reduce the necessary footprint.

As another example, rather than having a robotic arm moving between stations to conduct assays, it may be possible for one or more (or even all) of the stations to themselves move toward a central location where assays are set up and conducted. Such stations may be mounted on sliding rails, pivoting plates or tables, vertical conveyor belts, or other conveyances. This arrangement may reduce the distance traveled by reagents, which can reduce spillage and contamination.

As one specific example of this arrangement, a system may include a central main station, where sample ingestion, registration, and preparation occurs. This station may include tooling needed for sample enrichment, concentration (including centrifugation), and traceability. The sample shall be ready for loading onto the assay station after the steps at this station. Then, rather than a robotic arm to transfer aliquots of prepared samples to each assay station, the diagnostic station is configured to allow the instrument to move toward the main station. This arrangement can reduce the complexity and sources of error in sample transfer. Furthermore, this arrangement may allow the system to be more easily adapted to new types of diagnostic instruments and assays.

In addition, any of the systems described above may include different components/functions for any of the stations. Examples include: a small plate spectrophotometer; a sealer for PCR assay plates; a vacuum station for use with filter-plate based assays; a magnetic base for magnetic bead-based assays; and any instrument designed or engineered to fit at one position. For example, any of the off-deck stations may be an incubator, a wash station, a station for filling wash buffer plates, a real-time PCR system, a cartridge processor such as a Piper instrument or other, a results reader, or the like. Moreover, any of the pipettors discussed above may be single-well pipettors or may be configured to handle other numbers of pipettes (e.g., 8, 12, 24, 48, 96, or 384 wells). Flow-through pipettors connected to an external buffer source may also be adapted for use on this system. These may be connected to the gantry system 218c or be a stand-alone off-deck pipetting system. Another example, stations may be configured to distribute aliquots of a sample into specific wells of an assay plate or cartridge, tracking replicates, and producing a position plate/cartridge map.

As can be seen from the foregoing, embodiments of the invention can provide a food defense system designed to rapidly assay samples, interpret results and to communicate results to the food production-related facility to enable action to address any problem identified. In other words, the systems described above can be provided as a multi-station, end-to-end automated lab (from sample, through sample preparation, through assay, to results) with hardware, software, and data/traceability flow all integrated. The inventors believe this to be unique, particularly for the processing and assaying of certain pathogens and contaminants, such as TVB on environmental swabs, respiratory viruses on swabs and filters, and DNA sequencing of pathogens, and for an automated sample to result system that includes robotic solutions for all steps, including complex sample preparation. The system may be best implemented when the testing location is located close to or at the source of the samples being tested. This can eliminate delays related to the time required to ship samples to a testing lab, thereby removing result artifacts related to sample degradation or pathogen growth.

It should also be understood that, because the systems described herein can be largely, or even completely automated, results may be more consistent and reliable. In particularly, automated processes may help to ensure consistency in the manner in which the testing is conducted from day-to-day. Timing at each step of an assay can be precisely controlled to further increase assay precision. Also, significant or total automation can help to reduce or eliminate the possibility of cross-contamination, either between samples or between the operator and a sample. Testing has shown that automated systems are capable of rendering similar, if not more accurate, results from testing (e.g., similar numbers of positive and negative tests, reduced numbers of false positives and negatives, etc.).

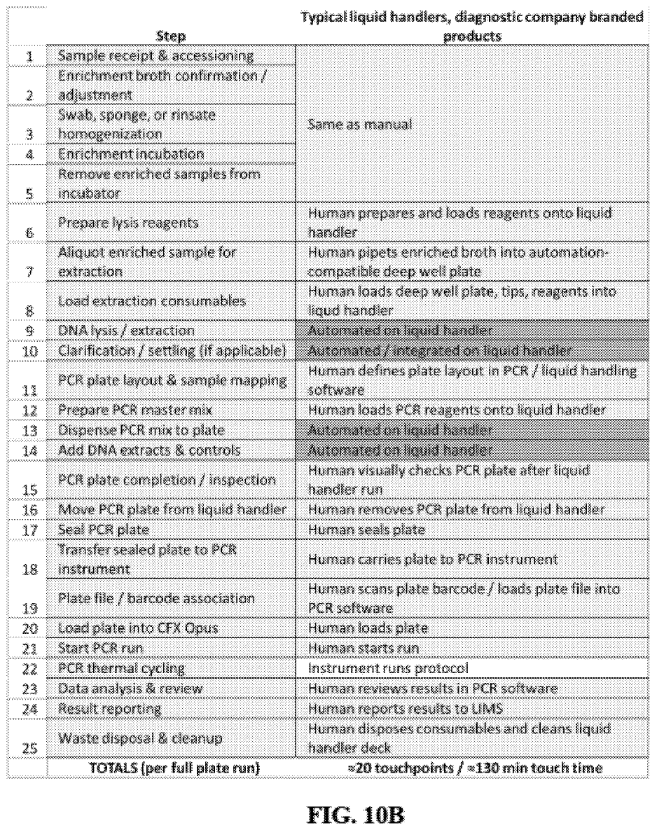

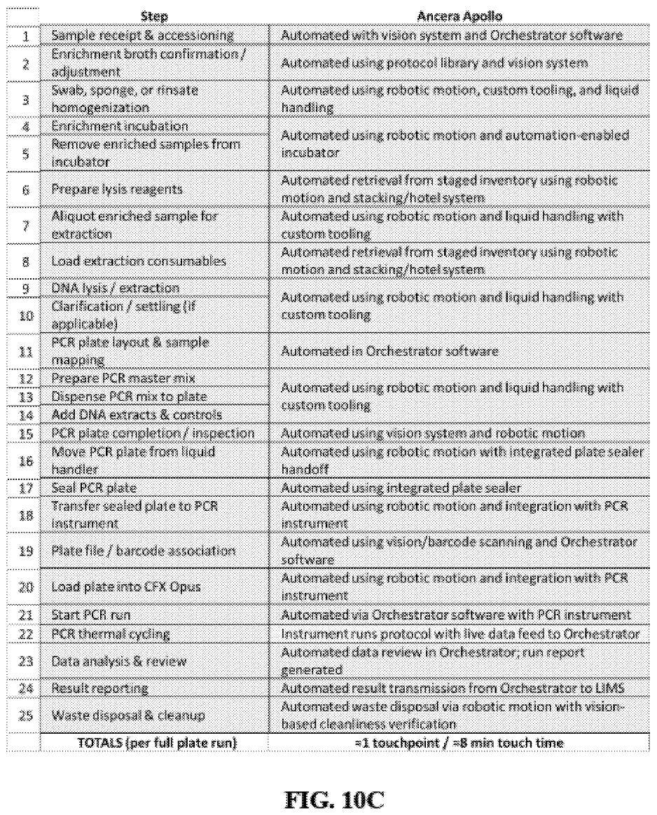

Moreover, the use of a completely automated system can save considerable time and labor in conducting testing. FIG. 9 is a chart showing how conducting Total Viable Bacteria (TVB) testing on a sample with an automated system such as that described above can reduce the amount of operator time from 7.5 hours to 0.5 hours. FIG. 10 is a table that compares the number of steps that require operator intervention or participation for testing for Listeria using a commercially available real-time polymerase chain reaction (PCR) assay wherein the testing is completely manual (Column 2 of FIG. 10), uses of a commercially-available liquid handler (Column 3 of FIG. 10) and a completely automated system according to embodiments of the invention (Column 4 of FIG. 10). FIG. 10 details the steps involved in sample preparation, enrichment, set-up of the PCR assay plate, processing of the PCR assay, and reporting of results for a Listeria monitoring assay on the platform. The system described in embodiments of this invention eliminates essentially all human touchpoints, including labor intensive sample homogenization, addition of enrichment media, and post-enrichment aliquoting of samples into plates, which must be done manually for conventional PCR preparation stations. By eliminating operator touchpoints, the system can not only save time, but it also reduces the chance for user errors and improves consistency of operations and results.

Further, it should be noted that the modular nature of the systems described herein may be desirable for users that wish to retain flexibility for scaling operations up or down, or for changing the types of assays being conducted at a given time. Significant or total automation may also ease such transitions.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A food defense system configured to perform specific food defense related assays on-site at a food production-related facility, comprising:
a housing;
at least one assay station mounted within the housing;
at least one reagent station mounted within the housing;
a supply of assay vessels residing within the housing;
a conveyance unit configured to move assay vessels to at least one assay station; and
a controller operatively connected with at least one of the at least one assay station, the conveyance unit, and the at least one reagent station.

2. The food defense system defined in claim 1, wherein the conveyance unit includes a robotic arm and a gantry system.

3. The food defense system defined in claim 1, wherein the conveyance unit is configured to move the assay vessels to the at least one reagent station.

4. The food defense system defined in claim 1, further comprising a transceiver operatively connected with the controller.

5. The food defense system defined in claim 1, wherein the housing has the general dimensions of a standard shipping container.

6. The food defense system defined in claim 1, located adjacent to or contiguous with the food production-related facility.

7. The food defense system defined in claim 1, further comprising a waste station mounted in the housing.

8. The food defense system defined in claim 1, further comprising a centrifuge mounted within the housing.

9. The food defense system defined in claim 1, further comprising a refrigeration unit within the housing.

10. The food defense system defined in claim 1, further comprising a heating unit within the housing.

11. A food defense system configured to perform specific food defense related assays on-site at a food production-related facility, comprising:
a housing;
a plurality of assay stations mounted within the housing;
a plurality of reagent stations mounted within the housing;
a supply of assay vessels residing within the housing;
a conveyance unit configured to move the assay vessels to one or more of the assay stations; and
a controller operatively connected with at least one of the assay stations, the conveyance unit, and the reagent stations.

12. The food defense system defined in claim 11, wherein the plurality of assay stations includes at least one first assay station and at least one second assay station, wherein the first and second assay stations are configured to perform different assays.

13. The food defense system defined in claim 11, wherein the plurality of reagent stations includes at least one first reagent station and at least one second reagent station, wherein the first and second reagent stations are configured to provide different reagents.

14. The food defense system defined in claim 11, wherein the conveyance unit includes a robotic arm and a gantry system.

15. The food defense system defined in claim 11, wherein the conveyance unit is configured to move the assay vessels to the plurality of reagent stations.

16. The food defense system defined in claim 11, wherein the housing has the general dimensions of a standard shipping container.

17. The food defense system defined in claim 11, located adjacent to or contiguous with the food production-related facility.

18. The food defense system defined in claim 11, further comprising a waste station mounted in the housing.

19. The food defense system defined in claim 11, further comprising a centrifuge mounted within the housing.

20. The food defense system defined in claim 11, further comprising at least one of a refrigeration unit and a heating unit within the housing.

21. A food defense system that can be configured to perform specific food defense-related assays on-site at a food production-related facility, the food defense system comprising:
at least one station for performing a food defense-related assay;
at least one station for providing at least one reagent for performing the assay; and
a conveyance unit for moving at least one component related to the assay to enable performance of the assay.

22. The food defense system defined in claim 21, located adjacent to or contiguous with the food production-related facility.

23. A food defense system designed for use on-site at a food production related facility to provide rapid analysis of samples.

24. The food defense system defined in claim 1, wherein the system is fully automated.

25. The food defense system defined in claim 11, wherein the system is fully automated.

26. The food defense system defined in claim 21, wherein the system is fully automated.

27. The food defense system defined in claim 1, wherein the system includes a station for homogenization of samples.

28. The food defense system defined in claim 27, wherein the station for homogenization of samples is configured to homogenize samples in bags.
